(19) United States
(12) Patent Application Publication
(10) Pub. No.: US 2020/0337354 A1
(43) Pub. Date: Oct. 29, 2020

(54) METHOD FOR PRODUCING POWDER OIL AND FAT COMPOSITION

(71) Applicant: J-OIL MILLS, INC., Tokyo (JP)

(72) Inventors: Takahiro TOKUCHI, Tokyo (JP); Hiroaki SUZUKI, Tokyo (JP); Misaki TSUJI, Tokyo (JP); Satoshi KONISHI, Tokyo (JP); Sanshiro SAITO, Tokyo (JP)

(21) Appl. No.: 16/762,324

(22) PCT Filed: Nov. 14, 2018
(86) PCT No.: PCT/JP2018/042093

§ 371 Date: May 7, 2020

(30) Foreign Application Priority Data
Nov. 22, 2017 (JP) 2017-224281

(51) Int. Cl. A23P 10/00; A23D 7/01

(52) U.S. Cl. CPC A23P 10/00; A23D 7/011

(57) ABSTRACT

[Problem] To provide a method for producing an oil and fat composition in which it is possible to enhance the flavor of a flavor oil.

[Solution] This method for producing a powder oil and fat composition includes a step for heating an oil mixture including a vegetable ingredient and an edible oil or fat at a temperature that is at least 45° C. and less than 100° C., and a step for obtaining the powder oil composition from a raw-ingredient mixture including the flavor oil and a diluent.

### TECHNICAL FIELD

The present invention relates to a method for producing a powder oil and fat composition, and more specifically to a method for producing a powder oil and fat composition containing a flavor oil.

### BACKGROUND ART

In general, a flavor oil (or spice oil) refers to an edible oil and fat which contains vegetable extracts having spicy flavors of Japanese leek, garlic, ginger, leek, and the like. The flavor oil can be generally obtained through a process that the vegetables are added into an oil and fat and heated.

For example, Patent Document 1 (Japanese Patent Application Laid-Open No. 56-58450) discloses a “method for producing a flavor oil, including: adding to a vegetable edible oil and fat; heating the oil and fat to 110 to 160° C.; and preserving it for a certain period”. Patent Document 1 describes that “ . . . heated until water in the vegetables substantially evaporates, and then heated to 110 to 160° C., so that a more favorable flavor can be provided” in the fifth line in the upper left column (-7-) of page 259. Patent Document 2 (Japanese Patent Application Laid-Open No. 3-254638) discloses that a “method for producing a spice oil, including: adding a dry or semidry vegetable ingredient having a water content of 30% or lower to the oil and fat; and heating the oil and fat at 100 to 115° C. for 10 to 60 minutes”. Patent Document 2 describes that “ . . . should be heated until the water content decreases to 30% or lower, and if the water content is higher than 30%, the vegetable should be heated with the oil and fat at a high temperature for a long time, resulting in impaired flavor” in the upper right column of page 220. Thus, in order to obtain a flavor oil having a favorable flavor, it is necessary to heat the oil and fat and the vegetables at a temperature where water in the vegetable substantially evaporates (100° C. or higher).

On the other hand, the powder oil and fat composition is a composition prepared by coating an oily component with a water-soluble component, and is widely used as a processed material such as coffee and tea cream, confectionery, soup, and seasoning. The powder oil and fat composition is produced by drying an emulsion of an edible oil and fat mixed with an emulsifier or excipient.

Patent Document 3 (Japanese Patent Application Laid-Open No. 2001-204407) discloses a powder composition containing Japanese leek oil in Example 3 of paragraph 0013, and describes that “Example 3 using lard and Japanese leek oil as oils/fats is particularly excellent as a processed rice improver for Chinese fried rice because a favorable spicy flavor can be provided to Chinese fried rice” in paragraph 0020. This document merely discloses that the powder oil and fat composition containing the flavor oil can provide a better flavor compared to a powder oil and fat composition containing no flavor oil.

### PRIOR ART DOCUMENTS

### Patent Documents

Patent Document 1: Japanese Patent Application Laid-Open No. 56-58450

Patent Document 2: Japanese Patent Application Laid-Open No. 3-254638

Patent Document 3: Japanese Patent Application Laid-Open No. 2001-204407

### SUMMARY OF INVENTION

### Problem to be Solved

An object of the present invention is to provide a method for producing an oil and fat composition capable of improving a flavor of a flavor oil. Another object of the present invention is to provide a method for improving a taste strength of a food by using the oil and fat composition obtained by the producing method.

### Solution to Problem

As a result of intensive studies on the above problems, the inventors of the present invention have found that a powder oil and fat composition obtained by blending a flavor oil prepared through a specific production process into a raw material can improve a flavor of the flavor oil, and this finding has led to completion of the invention. That means, the present invention relates to a method for producing a powder oil and fat composition, including steps of: heating an oil and fat mixture containing a vegetable ingredient and an edible oil and fat at 45° C. or higher and lower than 100° C. to obtain a flavor oil; and obtaining the powder oil and fat composition from a raw material mixture containing the flavor oil and an excipient.

Patent Document 3 does not disclose nor suggest that a flavor oil prepared through a specific production process is blended into a raw material of a powder oil and fat composition so that a flavor potency of the flavor oil and a taste strength of a food can be improved.

The vegetable ingredient is preferably one kind or two or more kinds of foods selected from Japanese leek, onion, chili pepper, garlic, great burdock, and pepper.

Preferably, a period for the heating is 10 minutes or more and 240 minutes or less.

Preferably, the oil and fat mixture further contains an emulsifier.

Preferably, the step of obtaining the flavor oil includes a filtration step after heating.

Preferably, the step of obtaining the powder oil and fat composition includes steps of:

(1) obtaining the raw material mixture containing the flavor oil, water, and the excipient;

(2) emulsifying the raw material mixture to obtain an emulsion; and

(3) drying the emulsion.

The present invention also relates to a method for improving flavor of a flavor oil, including steps of:

heating an oil and fat mixture containing a vegetable ingredient and an edible oil and fat at 45° C. or higher and lower than 100° C. to obtain a flavor oil; and obtaining a powder oil and fat composition from a raw material mixture containing the flavor oil and an excipient,

the step of obtaining the powder oil and fat composition including steps of:

(1) obtaining the raw material mixture containing the flavor oil, water, and the excipient;

(2) emulsifying the raw material mixture to obtain an emulsion; and

(3) drying the emulsion.

Preferably, the step of obtaining the flavor oil includes a filtration step after heating.

In addition, the present invention relates to a method for producing a food, the method including a step of adding the powder oil and fat composition obtained by the producing method to a foodstuff. A timing of adding the powder oil and fat composition to the foodstuff is not particularly limited, and the composition may be added at any time before or during production of the food, or added to the food in an edible state.

In addition, the present invention relates to a method for improving a taste strength of a food, the method consisting of adding the powder oil and fat composition obtained by the producing method to a foodstuff.

An addition amount of the powder oil and fat composition is preferably 0.1 parts by mass or more and 10 parts by mass or less, more preferably 0.5 parts by mass or more and 5 parts by mass or less per 100 parts by mass of the foodstuff.

### Effects of Invention

The method for producing the powder oil and fat composition according to the present invention can improve a flavor of a flavor oil prepared through a specific production process, and also improve a taste strength of a food containing the powder oil and fat composition obtained by the producing method.

### DESCRIPTION OF EMBODIMENTS

Hereinafter, embodiments of the present invention will be explained in detail. The flavor oil used in the method for producing the powder oil and fat composition according to the present invention is obtained by heating an edible oil and fat containing a vegetable ingredient at 45° C. or higher and lower than 100° C.

The aforementioned heating temperature is preferably 45° C. or higher and 95° C. or lower, more preferably 50° C. or higher and 95° C. or lower, even more preferably 50° C. or higher and 90° C. or lower, still even more preferably 50° C. or higher and 80° C. or lower, particularly preferably 50° C. or higher and 75° C. or lower, or most preferably 50° C. or higher and 70° C. or lower.

A period of the aforementioned heating is preferably 10 minutes or more and 240 minutes or less, more preferably 20 minutes or more and 240 minutes or less, even more preferably 20 minutes or more and 120 minutes or less, still even more preferably 20 minutes or more and 100 minutes or less, or particularly preferably 25 minutes or more and 80 minutes or less.

Preferably, after the heating, the flavor oil is obtained by a step of removing the vegetable ingredient. Preferably, the vegetable ingredient is removed by filtration. Preferably, a metal filter is used for filtration. A sieve opening of the metal filter is preferably 50 μm or more and 500 μm or less, more preferably 50 μm or more and 300 μm or less, even more preferably 100 μm or more and 300 μm or less.

Examples of the vegetable ingredient include: vegetables such as Japanese leek, onion, cabbage, bean sprout, leek, great burdock, carrot, celery, potato, and tomato; spices such as parsley, garlic, ginger, chili pepper, nutmeg, cumin, rosemary, pepper, zanthoxylum, horseradish, and basil; mushrooms such as shiitake mushroom, shimeji mushroom, matsutake mushroom, and maitake mushroom; and the like. One kind of vegetable ingredient may be used alone, or two or more kinds of vegetable ingredients may be used in combination.

Among them, vegetables and spices can be preferably exemplified. One kind or two or more kinds selected from welsh onions such as Japanese leek and onion, chili pepper, garlic, great burdock and pepper are preferable; one kind or two or more kinds selected from Japanese leek, onion, chili pepper, garlic, great burdock and pepper are more preferable; one kind or two or more kinds selected from Japanese leek, garlic, great burdock and pepper are even more preferable; and one kind or two kinds selected from garlic and pepper are still even more preferable.

A vegetable ingredient without processing or the like, i.e., a so-called fresh or an almost fresh vegetable ingredient may be used as it is, or the vegetable ingredient subjected to processing such as drying and freezing may be used. Preferably, the fresh or almost fresh vegetable ingredient is used.

When using a dry vegetable ingredient, it is preferable to add water during heating. An addition amount of water is preferably 10% by mass or more and 30% by mass or less, more preferably 10% by mass or more and 25% by mass or less, even more preferably 10% by mass or more and 20% by mass or less. A higher effect can be obtained by setting the addition amount of water to the predetermined amount.

The vegetable ingredient can be used in any state of liquid, paste, powder, solid, or the like without any limitation. When used in a solid state, a size of the vegetable ingredient is preferably 1 mm³ or more and 8000 mm³ or less, more preferably 1 mm³ or more and 5000 mm³ or less. For example, a vegetable ingredient cut into an appropriate size by means of a proper cutting means such as a multi-slicer or a food processor may be used. The vegetable ingredient can be easily removed from the heated edible oil and fat by setting the size to the above range.

The edible oil and fat is not particularly limited, and any edible oil and fat may be appropriately employed. Examples of the edible oil and fat include: vegetable oils and fats such as soybean oil, rapeseed oil, palm oil, corn oil, olive oil, sesame oil, safflower oil, sunflower oil, cottonseed oil, rice oil, peanut oil, palm kernel oil, and coconut oil; animal oils and fats such as beef tallow, lard, and chicken fat; or processed oils/fats obtained by subjecting these oils/fats to fractionation, hydrogenation, transesterification, or the like; and the like. One kind of edible oil and fat may be used alone, or two or more kinds of edible oils/fats may be used in combination. An iodine value of the edible oil and fat is preferably 0 or more and 160 or less, more preferably 0 or more and 100 or less, even more preferably 0 or more and 70 or less, still even more preferably 0 or more and 50 or less, particularly preferably 0 or more and 30 or less. Stability of the obtained powder oil and fat composition is improved by setting the iodine value to the predetermined value.

A melting point of the edible oil and fat is preferably 10° C. or higher, more preferably 15° C. or higher, even more preferably 20° C. or higher, still even more preferably 30° C. or higher, and although the upper limit of the melting point is not particularly restricted, the upper limit is 70° C. or lower, more preferably 55° C. or lower, even more preferably 45° C. or lower. The melting point used herein means a value measured in accordance with the “Standard Methods for the Analysis of Fats, Oils and Related Materials, 2.2.4.2 Melting Point (Raised Melting Point)”. An emulsion stability of the powder oil and fat composition during the production is improved by setting the melting point of the edible oil and fat to within the predetermined range.

When producing the flavor oil, an emulsifier may be contained in the oil and fat mixture containing the vegetable ingredient and the edible oil and fat before heating.

The emulsifier is not particularly limited as long as it is edible. One kind or two or more kinds selected from polyglycerin fatty acid ester, lecithin, sucrose fatty acid ester, monoglycerin fatty acid ester, sorbitan fatty acid ester and propylene glycol fatty acid ester are preferable. In terms of the flavor potency, one kind or two or more kinds selected from polyglycerin fatty acid ester and sucrose fatty acid ester are preferable. Also, in terms of the taste strength, one kind or two or more kinds selected from lecithin, sucrose fatty acid ester and monoglycerin fatty acid ester are preferable.

The fatty acid of the polyglycerol fatty acid ester is not particularly limited, but is preferably an unsaturated fatty acid, and more preferably oleic acid.

An average polymerization degree of glycerol in the polyglycerol fatty acid ester is preferably 2 or more and 10 or less, more preferably 2 to 8 or less, even more preferably 2 or more and 6, still even more preferably 2.

The lecithin is a generic term of lecithins conventionally used in the field of foods or food additives. It is possible to use a lecithin including a mixture containing phospholipid as an main ingredient, for example: a lecithin paste prepared from a by-product (e.g. hydrate generated in degumming step) in purification of vegetable oil such as soybean, rapeseed, corn, sunflower, palm, and peanut, and a crude raw material such as egg yolk; a fractionated lecithin obtained by fractionating the aforementioned crude raw material with a solvent; an enzymatically-decomposed lecithin obtained by enzymatically treating this crude raw material; and the like. In the present invention, the lecithin is not particularly limited, but a lecithin paste is preferable. In addition, the lecithin is preferably derived from soybean.

A content of acetone-insoluble substances in the lecithin is preferably 50 or more and 100% by mass or less, more preferably 50 or more and 80% by mass or less, even more preferably 55 or more and 70% by mass or less. The content of the acetone-insoluble substances in the lecithin can be calculated by measuring the content of the acetone-soluble substances in accordance with a handbook for Japanese Standards of Food Additives (5th edition, D, page 1054). Specifically, the content is a converted value in terms of the acetone-insoluble substances, which can be determined by the following measurement.

A mass of about 2 g (A) of lecithin is precisely weighed and put into a 50 mL graduated stoppered centrifuge tube, to which 3 mL of petroleum ether is added and dissolved, to which 15 mL of acetone is added and sufficiently stirred, and the mixture is left in ice water for 15 minutes. Acetone previously cooled to 0 to 5° C. is added to the mixture to adjust the volume to 50 mL, and the mixture is sufficiently stirred, left in ice water for 15 minutes, then centrifuged at about 3000 rpm for 10 minutes, and a supernatant liquid is collected in a flask. Furthermore, acetone at 0 to 5° C. is added to a precipitate in the stoppered centrifuge tube to adjust the volume to 50 mL, and the mixture is sufficiently stirred while cooling in ice water, and then centrifuged in the same manner. The supernatant liquid is added to the aforementioned flask, distilled in a water bath, a residue is dried at 105° C. for 1 hour, and a mass (B) of the residue is precisely measured.

This measurement makes it possible to determine a content of acetone-soluble substances in the lecithin. The content of the acetone-insoluble substances is calculated by the following equation.

Acetone-insoluble substance content (% by mass)=(1−B/A)×100 [Equation 1]

The fatty acid in the sucrose fatty acid ester is not particularly limited, but is preferably a saturated fatty acid.

The fatty acid in the monoglycerin fatty acid ester is not particularly limited, but is preferably a saturated fatty acid.

The fatty acid in the sorbitan fatty acid ester is not particularly limited, but is preferably a saturated fatty acid, and more preferably palmitic acid.

The fatty acid in the propylene glycol fatty acid ester is not particularly limited, but is preferably an unsaturated fatty acid, and more preferably oleic acid.

A content of the emulsifier in the oil and fat mixture is preferably 0.05% by mass or more and 5% by mass or less, more preferably 0.1% by mass or more and 3% by mass or less, even more preferably 0.3% by mass or more and 2% by mass or less, still even more preferably 0.3% by mass or more and 1% by mass or less. An effect of improving the flavor potency and the taste strength is enhanced by adding a predetermined emulsifier.

An HLB (Hydrophile-Lipophile Balance) of the emulsifier is preferably 1 or more and 18 or less, more preferably 1 or more and 15 or less, even more preferably 5 or more and 15 or less, still even more preferably 7 or more and 15 or less.

In the method for producing the powder oil and fat composition according to the present invention, an edible oil and fat other than flavor oils may be used, and the aforementioned edible oil and fat can be used. A melting point of the edible oil and fat is preferably 10° C. or higher, more preferably 15° C. or higher, even more preferably 20° C. or higher, most preferably 30° C. or higher. Although the upper limit of the melting point is not particularly restricted, the upper limit is 70° C. or lower. In particular, an emulsion stability of the powder oil and fat composition during the production is improved by setting the melting point of the edible oil and fat to within the predetermined range.

A content of the oil and fat contained in the powder oil and fat composition (oil content) is 5% by mass or more and to 80% by mass or less, preferably 10% by mass or more and 60% by mass or less, more preferably 20% by mass or more and 60% by mass or less, even more preferably 25% by mass or more and 55% by mass or less.

The excipient contained in the powder oil and fat composition is used mainly for the purpose of coating oily components to form a powder oil and fat composition and to prevent effusion of the oily components.

Examples of excipients include: saccharides such as starch (including octenyl succinate starch), sugar syrup, powder candy, corn syrup, sucrose, glucose, maltose, lactose, fructose, galactose, trehalose, dextrin, sodium alginate and carrageenan; sugar alcohols such as erythritol, sorbitol, mannitol, maltitol, lactitol, palatinit and reduced sugar syrup; flour; gelatin; gums such as xanthan gum, guar gum, gum arabic and gum tragacanth; and the like. These excipients may be used alone or in combination of two or more kinds. The excipient is preferably saccharides, more preferably one kind or two or more kinds selected from octenyl succinate starch, corn syrup, and dextrin, even more preferably one kind or two or more kinds selected from corn syrup and dextrin, and still even more preferably corn syrup.

The average molecular weight of the saccharides is preferably 400 or more and 20,000 or less, more preferably 500 or more and 15,000 or less.

In addition, the dextrose equivalent (DE) of the saccharides is preferably 10 or more and 50 or less, more preferably 10 or more and 40 or less, even more preferably 10 or more and 35 or less.

A content of the excipient in the powder oil and fat composition may be typically from 20% by mass or more and 90% by mass or less, and is preferably 30% by mass or more and 85% by mass or less, more preferably 40% by mass or more and 70% by mass or less. A powder oil and fat composition having good cold water dispersibility and good storage stability can be obtained by blending a predetermined amount of excipient.

Preferably, the powder oil and fat composition contains not only the flavor oil and the excipient but also an emulsifier. Preferably, the emulsifier is added in the step of obtaining the raw material mixture when producing the powder oil and fat composition, but the order of the addition is not limited. In addition, the emulsifier may be previously added when producing the flavor oil.

The emulsifier is not particularly limited, and any emulsifiers which are typically used for producing the powder oil and fat composition can be used. One kind or two or more kinds selected from polyglycerin fatty acid ester, lecithin, sucrose fatty acid ester, monoglycerin fatty acid ester, sorbitan fatty acid ester and propylene glycol fatty acid ester are preferable, and one or two kinds selected from monoglycerin fatty acid ester and sorbitan fatty acid ester are more preferable.

An HLB of the emulsifier is preferably 1 or more and 15 or less, more preferably 1 or more and 10 or less, even more preferably 2 or more and 8 or less.

Preferably, sodium caseinate is further added to the powder oil and fat composition.

In addition to the flavor oil and the excipient, auxiliaries commonly used for powder oil and fat compositions may be added to the powder oil and fat composition as long as they do not inhibit the effect of the present invention. Examples of such auxiliaries include: a pH conditioner such as dipotassium hydrogenphosphate, dipotassium sulfate and sodium citrate; an antioxidant such as tocopherol; a sweetener other than the above-mentioned excipients; a stabilizer; a flavoring agent; a colorant: calcium carbonate and titanium dioxide; and the like.

Preferably, the step of obtaining the powder oil and fat composition includes:

(1) obtaining the raw material mixture containing the flavor oil, water, and the excipient;

(2) emulsifying the raw material mixture to obtain an emulsion; and

(3) drying the emulsion.

An added amount of water in the step (1) may be typically 30 parts by mass or more and 200 parts by mass or less, and is preferably 30 parts by mass or more and 150 parts by mass or less per 100 parts by mass of the total of the flavor oil and the excipient.

Preferably, the raw material mixture is obtained by mixing an aqueous phase raw material containing water and the excipient with an oil phase raw material containing the flavor oil.

Preferably, the raw material mixture contains not only the flavor oil and the excipient but also an emulsifier. Preferably, the emulsifier is contained in the oil phase raw material. In this case, the emulsifier may be previously added when producing the flavor oil.

The step (2) may be performed with a general-purpose method and for example, emulsification is carried out by means of a homogenizer, a homomixer, a high-pressure emulsifying machine, a high-pressure homogenizing machine, a colloid mill or the like.

The step (3) may be performed with a general-purpose method and for example, vacuum drying, vacuum-freeze drying, vacuum belt drying, vacuum drum drying, spray drying using a spray dryer, or the like can be used.

The powder oil and fat composition obtained by the producing method according to the present invention can be used for a food requiring a flavor of a flavor oil by adding the powder oil and fat composition to a foodstuff. The foodstuff and the food are not particularly limited, and examples of the foodstuff and the food include premixed flour (flour for deep-fried food, etc.), roux (curry, stew, hashed beef with rice, etc.), instant cooked foods and drinks (instant noodle, instant soup, instant miso soup, etc.), retort foods (curry, stew, pasta sauce, soup, etc.), chilled/frozen foods (fried potato, deep-fried food, croquette, fried cake of minced meat, pork cutlet, gratin, pizza, Chinese fried rice, pilaf, steamed meat bun, dumpling, etc.), processed meat products (ham, bacon, sausage, hamburger, roast pork, seasoned meat, etc.), processed marine products (fish sausage, boiled fish paste, spicy cod roe, minced tuna, salt-pickled seafood, shrimp paste, etc.), seasonings (miso, sauce, tomato sauce, seasoning sauce, Chinese cooking seasoning, chicken stock powder, bouillon, pot cooking soup, etc.), confectionery and bread (potato chips, crackers, etc.), and the like. Furthermore, the above description also applies to foods for which a taste strength should be improved.

### EXAMPLES

The present invention will be explained in more detail below with reference to Examples and Comparative Examples of the present invention. However, the present invention is not limited to the following Examples. cl Preparation Example

For embodying the present invention, the following were used.

### <Edible Oil and Fat>

Extremely hardened palm kernel oil (melting point: 40° C., iodine value: 1, made by J-OIL MILLS, Inc.)

### <Excipient>

Corn Syrup (product name: Fuji Syrup C-75S, average molecular weight: 700, DE: 28, moisture content: 25% by mass, made by Kato Kagaku Co., Ltd.)

Dextrin (product name: Sun Deck #150, average molecular weight: 10000, DE: 15 to 18, made by Sanwa Starch Co., Ltd.)

### <pH Conditioner>

Dipotassium hydrogenphosphate (made by Taihei Chemical Industrial Co., Ltd.)

Sodium citrate (made by San-Ei Gen F.F.I., Inc.)

### <Emulsifier>

POEM DO-100V (diglycerin monoolate, HLB: 7.4, made by RIKEN VITAMIN CO., LTD.)

Lecithin (product name: Lecithin AY, made by J-OIL MILLS, Inc., content of acetone-soluble substance: 60% by mass, soybean lecithin paste)

DK ester F-160 (Sucrose fatty acid ester, HLB 15, made by DKS Co. Ltd.)

DK ester F-110 (Sucrose fatty acid ester, HLB 11, made by DKS Co. Ltd.)

DK ester F-50 (Sucrose fatty acid ester, HLB 6, made by DKS Co. Ltd.)

DK ester F-10 (Sucrose fatty acid ester, HLB 1, made by DKS Co. Ltd.)

POEM P-200 (monoglycerin fatty acid ester, HLB: 3.2, made by RIKEN VITAMIN CO., LTD.)

EMASOL P-10V (Sorbitan monopalmitate, HLB 6.7, made by Kao Corporation)

RIKEMAL PO-100V (propylene glycol oleic acid ester, HLB 3.6, made by RIKEN VITAMIN CO., LTD.)

### <Others>

Acid casein (Lactic Casein, made by Westland Co-operative Dairy Company Ltd.)

### <Method for Producing Flavor Oil>

An emulsifier was put into a pot as required, and further an extremely hardened palm kernel oil as an edible oil and fat was put into the pot, the pot was heated, and after the temperature reached a predetermined heating temperature, vegetable ingredients recited in the tables were added to the mixture, to which water is added as required. The mixture was further heated, and at a time when the temperature reached a predetermined heating temperature, the temperature was maintained. After the temperature reached the predetermined heating temperature and then maintained for a predetermined heating period, the mixture was filtered with a filter A (metal, sieve opening: 150 μm) (made by TOKYO SCREEN CO., LTD.), and a filtrate was collected to obtain a flavor oil.

<Method A for Producing powder Oil and Fat Composition (Oil Content: 50% by Mass)>

A powder oil and fat composition was produced in the following procedure.

### 1. Preparation of Aqueous Phase Raw Material

An aqueous solution containing sodium caseinate was obtained by mixing 85.1 parts by mass of water, 2.05 parts by mass of acid casein, and 0.05 part by mass of sodium hydroxide so as to neutralize the acid casein and sodium hydroxide. To this sodium caseinate aqueous solution, 59.7 parts by mass of corn syrup (solid content: 44.8 parts by mass, water content: 14.9 parts by mass), 1.6 parts by mass of dipotassium hydrogenphosphate, and 0.5 part by mass of trisodium citrate were mixed to obtain an aqueous phase raw material.

### 2. Preparation of Oil Phase Raw Material

To 50 parts by mass of the dissolved flavor oil, 0.5 part by mass of EMASOL P-10V and 0.5 part by mass of POEM P-200 were mixed to obtain an oil phase raw material.

### 3. High-Pressure Emulsification and Drying

A raw material mixture was obtained by mixing and stirring 149.0 parts by mass of the aqueous phase raw material and 51.0 parts by mass of the oil phase raw material. The raw material mixture was treated by a high-pressure emulsifying machine (product name: LAB-2000, made by SPX Corporation) at 500 bar to obtain an O/W-type emulsion. The obtained emulsion was dried into a powder form using a spray dryer (product name: B-290, made by BUCHI Labortechnik AG, Japan, inlet: 175° C., pump output 50%, atomized air flow rate: 600 L/hour) to obtain a powder oil and fat composition.

### <Method B for Producing Powder Oil and Fat Composition (Oil Content: 30% by Mass)>

A powder oil and fat composition was produced in the following procedure.

### 1. Preparation of Aqueous Phase Raw Material

An aqueous phase raw material was obtained by the same operation as in the aforementioned method A for producing powder oil and fat composition.

### 2. Preparation of Oil Phase Raw Material

An oil phase raw material was obtained by the same operation as in the aforementioned method A for producing powder oil and fat composition.

### 3. High-Pressure Emulsification and Drying

A raw material mixture was obtained by mixing and stirring 169.4 parts by mass of the aqueous phase raw material and 30.6 parts by mass of the oil phase raw material. The raw material mixture was treated by a high-pressure emulsifying machine (product name: LAB-2000, made by SPX Corporation) at 500 bar to obtain an O/W-type emulsion. The obtained emulsion was dried into a powder form using a spray dryer (product name: B-290, made by BUCHI Labortechnik AG, Japan, inlet: 175° C., pump output 50%, atomized air flow rate: 600 L/hour) to obtain a powder oil and fat composition.

### Example 1

### (Effect of Powder Oil and Fat Composition)

In accordance with the aforementioned method for producing flavor oil, a flavor oil was prepared under conditions given in Table 1. As a vegetable ingredient, raw garlic was coarsely minced using a mixer in advance before use.

In Example 1-1, the prepared flavor oil was treated in accordance with the aforementioned method B for producing powder oil and fat composition to obtain a powder oil and fat composition.

To 100 g of a soup prepared in accordance with the following Soup Formulation 1, 2 g of the obtained powder oil and fat composition was added to obtain a soup for evaluation (Example 1-1). In addition, to this soup, 0.6 g of the flavor oil was added instead of 2 g of the powder oil and fat composition to obtain a soup for evaluation (Comparative Example 1-1).

### (Soup Formulation 1)

Salt: 0.88 g,
Powdered sugar: 0.27 g,
Chemical seasoning (AJI-NO-MOTO (registered trademark), made by Ajinomoto Co., Inc.): 0.27 g,
Chicken extract (Chicken Stock 50-10-N, made by DSP GOKYO FOOD & CHEMICAL Co., Ltd.): 0.16 g,
White pepper (made by GABAN Co., Ltd.): 0.02 g,
Carrot powder (made by Mikasa Sangyo Co., Ltd.): 0.01 g,
Onion powder (made by GABAN Co., Ltd.): 0.03 g, and
Hot water: 98.36 g

The obtained soup for evaluation was tasted by three persons, and after consultation, the food was evaluated in accordance with the following evaluation criteria. The flavor potency refers to a peculiar fresh smell or taste derived from a vegetable ingredient, and the taste strength refers to a strength of a taste of a food. The results are shown in Table 1.

### (Evaluation Criteria)

### <Flavor Potency>

A: Very strong flavor
B: Strong flavor
C: Slightly weak flavor
D: Weak flavor

### <Taste Strength>

A: Very strong taste
B: Strong taste
C: Slightly weak taste
D: Weak taste

TABLE 1

| | | Example | Comparative |
|---|---|---|---|
| | | 1-1 | Example 1-1 |
| Raw material | Extremely hardened | 200 | 200 |
| of flavor oil | palm kernel oil | | |
| (g) | Raw garlic | 80 | 80 |
| Heating | Temperature (° C.) | 70 | 70 |
| condition of | Period (min) | 60 | 60 |
| flavor oil | | | |
| Form of flavor oil | | powder oil and | Flavor oil |
| | | fat composition | |
| Evaluation | Flavor potency | B | C |
| of food | Taste strength | B | C |

As shown in Table 1, it was found that, compared to a case of adding the flavor oil in Comparative Example 1-1 without processing to the soup, the flavor potency and the taste strength were improved by adding the flavor oil in the form of the powder oil and fat composition to the soup as indicated in Example 1-1.

### Example 2

### (Evaluation of Form of Vegetable Ingredient)

In accordance with the aforementioned method for producing flavor oil, a flavor oil was prepared under conditions given in Table 2. As a vegetable ingredient, raw garlic and garlic powder were used. When using raw garlic, the raw garlic was coarsely minced using a mixer in advance before use. As the garlic powder, garlic powder made by YOUKI FOOD Co., Ltd. was used. Note that the amount of the blended garlic powder in Examples 2-3 and 4 was set to correspond to the solid content of garlic in Example 2-1.

The prepared flavor oil was treated in accordance with the aforementioned method B for producing powder oil and fat composition to obtain a powder oil and fat composition.

To 100 g of a soup prepared in accordance with the aforementioned Soup Formulation 1, 2 g of the obtained powder oil and fat composition was added to obtain a soup for evaluation. The obtained soup for evaluation was tasted by three persons, and after consultation, the food was evaluated in accordance with the aforementioned evaluation criteria. The results are shown in Table 2.

TABLE 2

| | | Exam- | Exam- | Exam- | Exam- |
|---|---|---|---|---|---|
| | | ple | ple | ple | ple |
| | | 2-1 | 2-2 | 2-3 | 2-4 |
| Raw material of | Extremely | 200 | 198 | 198 | 198 |
| flavor oil (g) | hardened palm | | | | |
| | kernel oil | | | | |
| | Emulsifier | — | 2 | 2 | 2 |
| | POEM DO-100V | | | | |
| | Raw garlic | 80 | 80 | — | — |
| | Garlic powder | — | — | 28.8 | 28.8 |
| | Water | — | — | — | 51.2 |
| Heating condition | Temperature (° C.) | 70 | 70 | 70 | 70 |
| of flavor oil | Period (min) | 60 | 60 | 60 | 60 |
| Evaluation of | Flavor potency | B | A | B | A |
| food | Taste strength | B | A | B | A |

As shown in Table 2, in both cases using garlic and garlic powder (dry garlic) as vegetable ingredients, and the flavor potencies were sufficient, and the taste strengths were favorable. When comparing Example 2-1 with Example 2-2, it is found that the effects for the flavor potency and the taste strength are improved by adding POEM DO-100V. In addition, when comparing Example 2-3 with Example 2-4, it is found that, in a case of a dry vegetable ingredient, the effects for the flavor potency and the taste strength are improved by adding water during heating.

### Example 3

### (Evaluation of Heating Temperature 1)

In accordance with the aforementioned method for producing flavor oil, a flavor oil was prepared under conditions given in Table 3. As a vegetable ingredient, raw garlic was coarsely minced using a mixer in advance before use.

The prepared flavor oil was treated in accordance with the aforementioned method B for producing powder oil and fat composition to obtain a powder oil and fat composition.

To 100 g of a soup prepared in accordance with the aforementioned Soup Formulation 1, 2 g of the obtained powder oil and fat composition was added to obtain a soup for evaluation. The obtained soup for evaluation was tasted by three persons, and after consultation, the food was evaluated in accordance with the aforementioned evaluation criteria. The results are shown in Table 3.

TABLE 3

| | | Ex- | Ex- | Ex- | Com- | Com- |
|---|---|---|---|---|---|---|
| | | am- | am- | am- | parative | parative |
| | | ple | ple | ple | Example | Example |
| | | 3-1 | 3-2 | 3-3 | 3-1 | 3-2 |
| Raw | Extremely | 198 | 198 | 198 | 198 | 198 |
| material of | hardened palm | | | | | |
| flavor oil | kernel oil | | | | | |
| (g) | Emulsifier | 2 | 2 | 2 | 2 | 2 |
| | POEM DO- | | | | | |
| | 100V | | | | | |
| | Raw garlic | 80 | 80 | 80 | 80 | 80 |
| Heating | Temperature | 50 | 70 | 90 | 100 | 110 |
| condition of | (° C.) | | | | | |
| flavor oil | Period (min) | 60 | 60 | 60 | 60 | 60 |
| Evaluation | Flavor potency | A | A | B | C | D |
| of food | Taste strength | A | A | C | C | C |

As shown in Table 3, the flavor potency was favorable when the heating temperature was 50° C. or higher and 90° C. or lower as indicated in Examples 3-1 to 3-3. On the other hand, in the cases of the heating temperatures at 100° C. and 110° C., the flavor potencies were insufficient as indicated in Comparative Examples 3-1 and 3-2. It was found that the heating temperature was more preferably 50° C. or higher and 70° C. or lower from the viewpoints of the flavor potency and the taste strength.

### Example 4

### (Evaluation of Heating Temperature 2)

In accordance with the aforementioned method for producing flavor oil, a flavor oil was prepared under conditions given in Table 4. As a vegetable ingredient, garlic powder was used.

The prepared flavor oil was treated in accordance with the aforementioned method B for producing powder oil and fat composition to obtain a powder oil and fat composition.

To 100 g of a soup prepared in accordance with the aforementioned Soup Formulation 1, 2 g of the obtained powder oil and fat composition was added to obtain a soup for evaluation. The obtained soup for evaluation was tasted by three persons, and after consultation, the food was evaluated in accordance with the aforementioned evaluation criteria. The results are shown in Table 4.

TABLE 4

| | | Example | Comparative |
|---|---|---|---|
| | | 4-1 | Example 4-1 |
| Raw material of | Extremely hardened | 198 | 198 |
| flavor oil (g) | palm kernel oil | | |
| | Emulsifier | 2 | 2 |
| | POEM DO-100V | | |
| | Garlic powder | 28.8 | 28.8 |
| | Water | 51.2 | 51.2 |
| Heating condition | Temperature (° C.) | 70 | 110 |
| of flavor oil | Period (min) | 60 | 60 |
| Evaluation | Flavor potency | A | D |
| of food | Taste strength | A | C |

As shown in Table 4, the flavor potency and the taste strength were favorable when the heating temperature was 70° C. as indicated in Example 4-1. In the case of the heating temperature at 110° C., the flavor potency was insufficient as indicated in Comparative Example 4-1.

### Example 5

### (Evaluation of Emulsifier)

In accordance with the aforementioned method for producing flavor oil, a flavor oil was prepared under conditions given in Table 5. As a vegetable ingredient, raw garlic was coarsely minced using a mixer in advance before use.

The prepared flavor oil was treated in accordance with the aforementioned method B for producing powder oil and fat composition to obtain a powder oil and fat composition.

To 100 g of a soup prepared in accordance with the aforementioned Soup Formulation 1, 2 g of the obtained powder oil and fat composition was added to obtain a soup for evaluation. The obtained soup for evaluation was tasted by three persons, and after consultation, the food was evaluated in accordance with the aforementioned evaluation criteria. The results are shown in Table 5.

TABLE 5

| | | Example | Example | Example | Example | Example | Example | Example | Example | Example |
|---|---|---|---|---|---|---|---|---|---|---|
| | | 5-1 | 5-2 | 5-3 | 5-4 | 5-5 | 5-6 | 5-7 | 5-8 | 5-9 |
| Raw | Extremely | 198 | 198 | 198 | 198 | 198 | 198 | 198 | 198 | 198 |
| material of | hardened palm | | | | | | | | | |
| flavor oil | kernel oil | | | | | | | | | |
| (g) | Emulsifier | 2 | 2 | 2 | 2 | 2 | 2 | 2 | 2 | 2 |
| | (described | | | | | | | | | |
| | below) | | | | | | | | | |
| | Raw garlic | 80 | 80 | 80 | 80 | 80 | 80 | 80 | 80 | 80 |
| Emulsifier | | POEM | Lecithin | DK Ester | DK Ester | DK Ester | DK Ester | POEM P- | EMASOL | RIKEMAL |
| | | DO-100V | | F160 | F110 | F50 | F10 | 200 | P-10V | PO-100V |
| Heating | Temperature | 70 | 70 | 70 | 70 | 70 | 70 | 70 | 70 | 70 |
| condition of | (° C.) | | | | | | | | | |
| flavor oil | Period (min) | 60 | 60 | 60 | 60 | 60 | 60 | 60 | 60 | 60 |
| Evaluation | Flavor potency | A | B | A | A | A | B | B | B | B |
| of food | Taste strength | A | A | A | A | B | A | A | B | B |

As shown in Table 5, it was found that, when a flavor oil was produced, the flavor potency or the taste strength could be improved by adding an emulsifier. In particular, it was found that POEM DO-100V, DK ESTER F160, DK ESTER F110, and DK ESTER F50 were preferable from the viewpoint of improving the flavor potency. Also, it was found that POEM DO-100V, lecithin, DK ESTER F160, DK ESTER F110, DK ESTER F10, and POEM P-200 were preferable from the viewpoint of improving the taste strength.

### Example 6

(Evaluation of Oil Content of powder Oil and Fat Composition and Excipient)

In accordance with the aforementioned method for producing flavor oil, a flavor oil was prepared under conditions given in Table 6. As a vegetable ingredient, raw garlic was coarsely minced using a mixer in advance before use.

In Example 6-1, a powder oil and fat composition having a flavor oil content of 50% by mass was obtained in accordance with the aforementioned method A for producing powder oil and fat composition. In Example 6-2, a powder oil and fat composition having a flavor oil content of 30% by mass was obtained in accordance with the aforementioned method A for producing powder oil and fat composition. In Example 6-3, a powder oil and fat composition was obtained by the same operation as in the method B for producing powder oil and fat composition except that the corn syrup as the aqueous phase raw material in preparing the powder oil and fat composition was replaced by 44.8 parts by mass of dextrin, and 85.1 parts by mass of water was replaced by 100 parts by mass of water.

To 100 g of a soup prepared in accordance with the aforementioned Soup Formulation 1, 2 g of the obtained powder oil and fat composition is added to obtain a soup for evaluation. The obtained soup for evaluation was tasted by three persons, and after consultation, the food was evaluated in accordance with the aforementioned evaluation criteria. The results are shown in Table 6.

TABLE 6

| | | Exam- | Exam- | Exam- |
|---|---|---|---|---|
| | | ple 6-1 | ple 6-2 | ple 6-3 |
| Raw material of | Extremely | 200 | 200 | 200 |
| flavor oil (g) | hardened palm | | | |
| | kernel oil | | | |
| | Raw garlic | 80 | 80 | 80 |
| Heating | Temperature (° C.) | 70 | 70 | 70 |
| condition of | Period (min) | 60 | 60 | 60 |
| flavor oil | | | | |
| powder oil and | Oil content | 50 | 30 | 50 |
| fat composition | (% by mass) | | | |
| | Excipient | Corn | Corn | Dextrin |
| | | syrup | syrup | |
| Evaluation of | Flavor potency | B | B | B |
| food | Taste strength | B | B | B |

As shown in Table 6, in both cases of 30% by mass and 50% by mass of the oil contents in the powder oil and fat composition, effects of improving the flavor potency and the taste strength could be confirmed, and the effects in the cases were equivalent to each other. (Example 6-1 and Example 6-2). Also, it was found that even if dextrin was used instead of the corn syrup as the excipient, the same effect could be obtained

### Example 7

### (Evaluation of Vegetable Ingredient Other Than Garlic)

A flavor oil was prepared under the conditions given in Table 7 in accordance with the aforementioned method for producing flavor oil. As vegetable ingredients, Japanese leek, great burdock, and pepper were used, and Japanese leek and great burdock were coarsely minced using a mixer in advance before use. Pepper was ground in advance before use.

The prepared flavor oil was treated in accordance with the aforementioned method B for producing powder oil and fat composition to obtain a powder oil and fat composition.

To 100 g of a soup prepared in accordance with the aforementioned Soup Formulation 1, 2 g of the obtained powder oil and fat composition is added to obtain a soup for evaluation. The obtained soup for evaluation was tasted by three persons, and after consultation, the food was evaluated in accordance with the aforementioned evaluation criteria. The results are shown in Table 7.

TABLE 7

| | | Example | Example | Example |
|---|---|---|---|---|
| | | 7-1 | 7-2 | 7-3 |
| Raw material of | Extremely | 198 | 198 | 198 |
| flavor oil (g) | hardened palm | | | |
| | kernel oil | | | |
| | Emulsifier | 2 | 2 | 2 |
| | POEM DO-100V | | | |
| | Japanese Leek | 80 | — | — |
| | Great burdock | — | 80 | — |
| | Pepper | — | — | 80 |
| Heating | Temperature (° C.) | 70 | 70 | 70 |
| condition of | Period (min) | 60 | 60 | 60 |
| flavor oil | | | | |
| Evaluation of | Flavor potency | B | A | A |
| food | Taste strength | A | B | A |

As shown in Table 7, it was found that, also in cases of using vegetable ingredients other than garlic, effects for improving the flavor potency and the taste strength were exhibited.

### Example 8

### (Evaluation of Heating Period)

In accordance with the aforementioned method for producing flavor oil, a flavor oil was prepared under conditions given in Table 8. As a vegetable ingredient, raw garlic was coarsely minced using a mixer in advance before use.

The prepared flavor oil was treated in accordance with the aforementioned method B for producing powder oil and fat composition to obtain a powder oil and fat composition.

To 100 g of a soup prepared in accordance with the Soup Formulation 1, 2 g of the obtained powder oil and fat composition is added to obtain a soup for evaluation. The obtained soup for evaluation was tasted by three persons, and after consultation, the food was evaluated in accordance with the aforementioned evaluation criteria. The results are shown in Table 8.

TABLE 8

| | | Exam- | Exam- | Exam- |
|---|---|---|---|---|
| | | ple 8-1 | ple 8-2 | ple 8-3 |
| Raw material of | Extremely hardened | 198 | 198 | 198 |
| flavor oil (g) | palm kernel oil | | | |
| | Emulsifier | 2 | 2 | 2 |
| | POEM DO-100V | | | |
| | Raw garlic | 80 | 80 | 80 |
| Heating condition | Temperature (° C.) | 70 | 70 | 70 |
| of flavor oil | Period (min) | 60 | 30 | 120 |
| Evaluation of | Flavor potency | A | A | B |
| food | Taste strength | A | A | B |

As shown in Table 8, it was found that when the heating period was 30 minutes or more and 120 minutes or less, effects for improving the flavor potency and the taste strength could be obtained, and also it was found that the heating period was preferably 30 minutes or more and 60 minutes or less.

1. A method for producing a powder oil and fat composition, comprising steps of:
heating an oil and fat mixture containing a vegetable ingredient and an edible oil and fat at 45° C. or more and lower than 100° C. to obtain a flavor oil; and
obtaining the powder oil and fat composition from a raw material mixture containing the flavor oil and an excipient.

2. The method for producing as claimed in claim 1, wherein the vegetable ingredient is one or more foods selected from Japanese leek, onion, chili pepper, garlic, great burdock, and pepper.

3. The method for producing as claimed in claim 1, wherein a period for the heating is 10 minutes or more and 240 minutes or less.

4. The method for producing as claimed in claim 1, wherein the oil and fat mixture further contains an emulsifier.

5. The method for producing as claimed in claim 1, wherein the step of obtaining the flavor oil comprises a filtration step after heating.

6. The method for producing as claimed in claim 1, wherein the step of obtaining the powder oil and fat composition comprises steps of:
(1) obtaining the raw material mixture containing the flavor oil, water, and the excipient;
(2) emulsifying the raw material mixture to obtain an emulsion; and
(3) drying the emulsion.

7. A method for improving flavor of a flavor oil, comprising steps of:
heating an oil and fat mixture containing a vegetable ingredient and an edible oil and fat at 45° C. or more and lower than 100° C. to obtain a flavor oil; and
obtaining a powder oil and fat composition from a raw material mixture containing the flavor oil and an excipient,
the step of obtaining the powder oil and fat composition comprising steps of:
(1) obtaining the raw material mixture containing the flavor oil, water, and the excipient;
(2) emulsifying the raw material mixture to obtain an emulsion; and
(3) drying the emulsion.

8. The method as claimed in claim 7, wherein the step of obtaining the flavor oil comprises a filtration step after heating.

9. A method for producing a food, comprising a step of adding the powder oil and fat composition obtained by the method for producing as claimed in claim 1 to a foodstuff.

10. A method for improving a taste strength of a food, consisting of adding the powder oil and fat composition obtained by the method for producing as claimed in claim 1 to a foodstuff.
